(19) United States
(12) Patent Application Publication
(10) Pub. No.: US 2012/0256474 A1
(43) Pub. Date: Oct. 11, 2012

(54) Wheel Assembly with Reversible Adaptor

(75) Inventors: Gopal K. Gorle, Srikakulam (IN); Keith Kabrick, Springfield, IL (US)

(73) Assignee: CATERPILLAR, INC., Peoria, IL (US)

(21) Appl. No.: 13/080,135

(22) Filed: Apr. 5, 2011

(51) Int. Cl. B60B 23/00; B21D 53/26; B60B 27/00

(52) U.S. Cl. 301/105.1; 301/111.04; 29/894.361

(57) ABSTRACT

An adaptor for a wheel assembly is disclosed. The adaptor has a reversible design for convenient reconfiguration of the wheel assembly without additional hardware. In one general non-limiting embodiment, the adaptor may include an inner ring and an outer ring fixedly connected to the inner ring. The inner and outer rings may be concentric around an axis. The inner and outer rings may be offset from each other. Methods of using the adaptor to change wheel configurations to accommodate different tire sizes are also disclosed.

### BACKGROUND

1. Technical Field

This disclosure generally relates to an adaptor for a wheel assembly and particularly to a reversible adaptor for convenient reconfiguration of the wheel assembly without additional hardware.

2. Description of the Related Art

Load-bearing vehicles, such as off-highway trucks and camping vehicles often use dual-wheel configurations on the rear drive axles of the vehicles. Such dual-wheel configurations generally have an axle with a pair of closely spaced wheels positioned at each end of the axle. Generally, all four wheels on the dual-wheel axle are directly driven by the axle structure. As a result, the load bearing capability of the vehicle may be increased with all four tires sharing the load previously distributed to two tires. Further, the dual-wheel configuration increases traction as the traction surface of the tires is doubled as compared to a single-wheel configuration.

Thus, the majority of truck and camper manufacturers generally make available an option permitting the customer to select the dual wheel configuration at the time of purchase. Some truck manufacturers use duel wheel configuration as standard on their load-bearing vehicles. When so provided, these vehicles are available with a standard single wheel configuration on the front two wheels of the vehicle and a four wheel dual pair arrangement on the rear. While such originally manufactured versions having factory installed dual wheel configurations do provide increased load-bearing and traction, they are subject to several limitations. For example, as discussed above, such vehicles may need to be earmarked for dual wheel construction during the manufacturing process. Because of the general construction techniques of vehicles, it is generally expensive and difficult to convert such systems subsequent to manufacture.

Wheel adapters are known in automobile manufacturing and customization for many years. In general, wheel adapters are used to install aftermarket wheels that are different from the original wheels provided by the vehicle manufacturer. For example, wheel adapters may be used to install a wheel that has a different bolt pattern, to install a wheel that has a different dimension, to install a wheel that increases the track of the vehicle, or to convert a single rear wheel to a dual rear wheel.

Existing wheel adaptors generally include an inner ring connected to an outer ring. The inner ring is adapted to be connected to a hub while the outer ring is adapted to be connected to the wheel to be mounted. The inner and outer rings are generally in alignment or registration with each other. As discussed above, the inner and outer rings are generally designed to mount different wheels rather than to accommodate different tire sizes on the same wheel.

### SUMMARY OF THE DISCLOSURE

An adaptor for a wheel assembly is disclosed. The adaptor has a reversible design for convenient reconfiguration of the wheel assembly without additional hardware. In one general, non-limiting embodiment, the adaptor may include an inner ring and an outer ring fixedly connected to the inner ring. The inner and outer rings may be concentric around an axis. The inner and outer rings may be offset from each other.

In another non-limiting embodiment, a wheel assembly is disclosed as including a hub, a wheel, and a wheel adaptor. The wheel adaptor may include an inner ring connected to the hub and an outer ring connected to the wheel. The inner and outer rings may be concentric around an axis. The inner and outer rings may be offset from each other.

A method for reconfiguring a wheel assembly that includes a hub, a wheel, and an adaptor interconnecting the hub and wheel is also disclosed. The method may include the steps of disconnecting the wheel and adaptor, disconnecting the adaptor and hub, reversing the adaptor, reconnecting the adaptor and hub, and reconnecting the wheel and adaptor.

The term “offset” used throughout this disclosure to describe the two interconnected and concentric rings of the wheel adaptor should be interpreted as referring to a spatial relationship in which neither ring is in alignment or registration with the other (i.e. neither ring is completely positioned between the two parallel planes defined by the other ring). This interpretation is consistent with both the ordinary meaning of the term “offset” and the conventional understanding and usage of the term “offset” in the mechanical art.

Other advantages and features of the disclosed adaptor and wheel assembly and the method of use thereof will be described in greater detail below. It will also be noted here and elsewhere that the apparatus or method disclosed herein may be suitably modified to be used in a wide variety of applications by one of ordinary skill in the art without undue experimentation.

### BRIEF DESCRIPTION OF THE DRAWINGS

For a more complete understanding of the disclosed apparatus and method, reference should be made to the embodiments illustrated in greater detail in the accompanying drawings, wherein:

FIG. 1 is a perspective view of an earth-moving vehicle in which a wheel assembly according to this disclosure is used;

FIG. 2 is a cross-sectional view of a wheel assembly according to one embodiment of this disclosure;

FIG. 3 is an enlarged partial view of the wheel assembly in FIG. 2, particularly illustrating the wheel adaptor configured to accommodate narrower tires;

FIG. 4 is a cross-sectional view of a wheel assembly according to another embodiment of this disclosure; and

FIG. 5 is an enlarged partial view of the wheel assembly in FIG. 4, particularly illustrating the wheel adaptor configured to accommodate wider tires.

It should be understood that the drawings are not necessarily to scale and that the disclosed embodiments are sometimes illustrated diagrammatically and in partial views. In certain instances, details which are not necessary for an understanding of the disclosed apparatus or method which render other details difficult to perceive may have been omitted. It should be understood, of course, that this disclosure is not limited to the particular embodiments illustrated herein.

### DETAILED DESCRIPTION OF THE DISCLOSURE

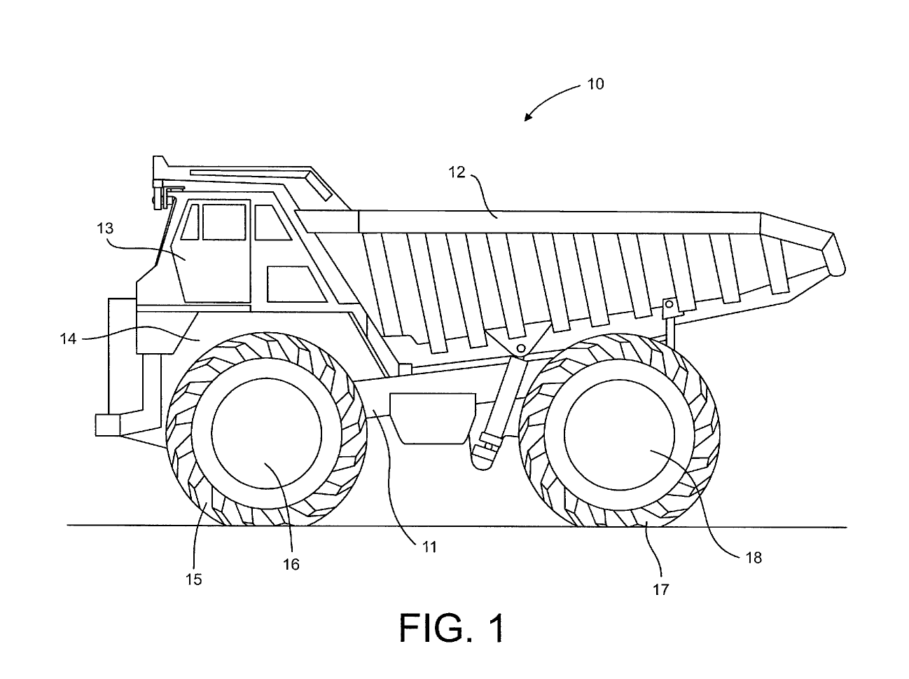

Referring now to FIG. 1, an earth-moving vehicle 10 is illustrated as generally including a main frame 11, a dump body 12 pivotally mounted to the main frame 11, an operator cab 13 mounted on the front of the main frame 11 above an engine enclosure 14. The vehicle 10 is supported on the ground by front tires 15 (one shown) each mounted on a front wheel assembly 16, and rear tires 17 (one shown) each mounted on a back (driven) wheel assembly 18. One or more engines (not shown) may be housed within the engine enclosure 14 to supply power to the driven wheel assembly 18 via a mechanical or electric drive train.

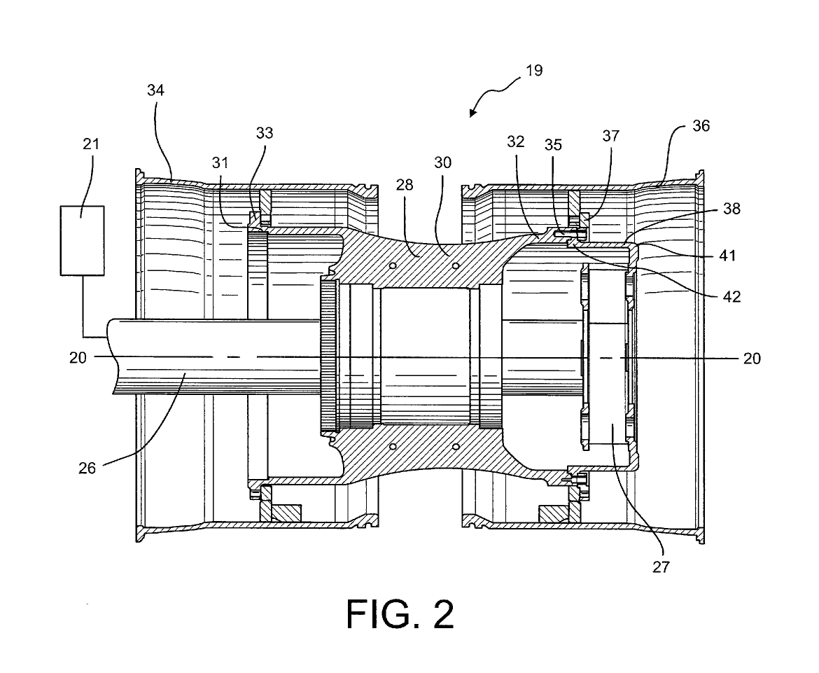

As discussed before, the driven wheel assembly 18 may have two or even more wheels on each side to improve the load bearing and/or traction of the vehicle 10. Referring now to FIG. 2, a wheel assembly 19 (showing only one side) according to this disclosure is illustrated as generally defined about a horizontal central axis 20. The wheel assembly 19 is operatively connected to and driven by a final drive assembly 27 that is coupled to a driven train (not shown) of the vehicle 10 through an input (or drive) shaft 26. As used in this disclosure, the term “proximal” refers to a direction that is toward the driven train and the term “distal” refers to a direction that is away from the drive train.

According to one embodiment of this disclosure, the wheel assembly 19 includes a hub 28 defined about the central axis 20. The hub 28 includes a sidewall 30 axially extending between a proximal end 31 and a distal end 32. The proximal end 31 includes a radially outwardly extending proximal mounting flange 33 defined about the central axis 20. A proximal rim 34 is mounted on the proximal mounting flange 33. The distal end 32 also includes a radially outwardly extending distal mounting flange 35, also defined about the central axis 20. A distal rim 36 is mounted on the distal end 32 of the hub 28 through a wheel adaptor 37, the details of which are described later in this disclosure.

The wheel assembly 19 may include a planetary carrier 38 (also defined about the central axis 20) through which the final drive assembly 27 is coupled to the hub 28. To that end, the planetary carrier 38 includes a distal mounting flange 41 for coupling with the final drive assembly 27, and a proximal mounting flange 42 for coupling with the distal mounting flange 35 of the hub 28. As a result, rotation of the final drive assembly 27 is translated into the rotation of the wheel assembly 19 to drive the vehicle 10.

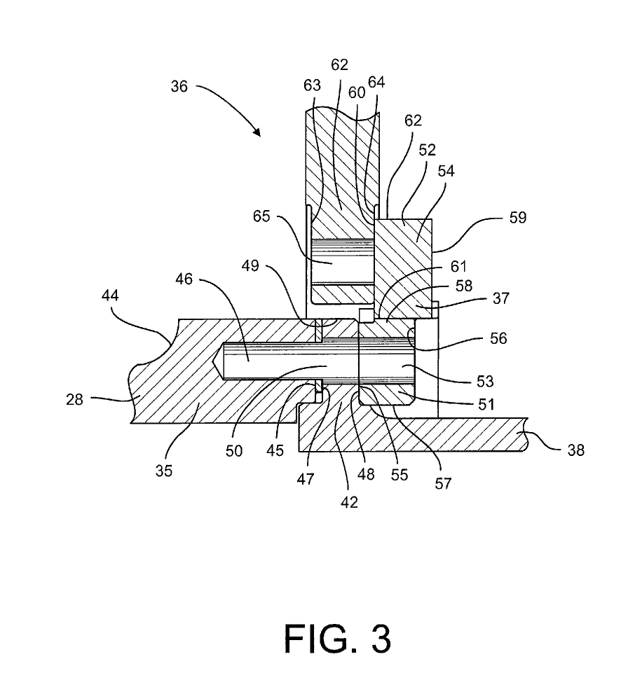

Turning now to FIG. 3, the distal mounting flange 35 of the hub 28 may include a proximal surface 44 and a distal surface 45. A plurality of mounting bores 46 are provided on the mounting flange 35 about the central axis 20. The mounting bores 46 may be threaded or smooth. The mounting flange 42 of the planetary carrier 38 also includes a proximal surface 47, a distal surface 48 and an outside edge 49 extending between the proximal and distal surfaces (47, 48). A plurality of mounting bores 50 are provided on the mounting flange 42 about the central axis 20. The mounting bores 50 may be threaded or smooth.

Turning back to FIG. 2, the distal rim 36 is mounted on the hub 28 through the wheel adaptor 37. As illustrated in greater detail in FIG. 3, the wheel adaptor 37 may include an inner ring 51 and an outer ring 52, both of which may be concentrically defined around the central axis 20. The outer ring 52 is fixedly connected to the inner ring 51. The inner and outer rings (51, 52) may be of essentially the same axial thickness in some non-limiting embodiments of the present application, as illustrated in FIG. 3. In one embodiment, the inner and outer rings (51, 52) are integrated into a one-piece construction. To interconnect the hub 28 and the distal rim 36, both rings (51, 52) include a plurality of mounting bores (53, 54) radially arranged about the central axis 20. In some embodiments, the mounting bores (53, 54) are evenly distributed around the central axis 20.

One feature of the disclosed wheel adaptor 37 is that the inner and outer rings (51, 52) may be offset from each other so that neither ring is in alignment or registration with each other. For example, the inner ring 51 may include an end surface 55, a stepped surface 56, and inner and outer edges (57, 58) extending between the end and stepped surfaces (55, 56). Similarly, the outer ring 52 may also include an end surface 59, a stepped surface 60, and inner and outer edges (61, 62) extending between the end and stepped surfaces (59, 60). When the inner and outer rings (51, 52) are integrated into one-piece, the outer edge 58 of the inner ring 51 and the inner edge 61 of the outer ring 52 may be partially merged together. As illustrated in FIG. 3, the stepped surface 56 of the inner ring 51 may be connected to the inner edge 61 of the outer ring 52, and the stepped surface 60 of the outer ring 52 may be connected to the outer edge 58 of the inner ring 51. The end surfaces (55, 59) of the inner and outer rings (51, 52), on the other hand, are not connected to either of the edges (58, 61). As a result, neither ring is completely positioned between the two parallel planes defined by the stepped and end surfaces of the other ring, and thus “offset” from one another.

As discussed earlier, the wheel adaptor 37 may have two configurations to accommodate differently sized tires. A first adaptor configuration is illustrated in FIGS. 2-3 with the outer ring 52 positioned distal to the inner ring 51. In the non-limiting embodiment shown in FIG. 3, the end surface 55 of the inner ring 51 abuts against the distal surface 48 of the mounting flange 42 of the planetary carrier 38 while the proximal surface 47 of the mounting flange 42 abuts against the distal mounting flange 35 of the hub 28. At least some of the mounting bores (46, 50, 53) are in axial registration with one another so that the inner ring 51 of the wheel adaptor 37 can be fixedly connected to the distal mounting flange 35 and the mounting flange 42 of the planetary carrier 38, such as through a plurality of inner ring fasteners (not shown), including but not limited to studs, screws, bolts, etc. It is to be understood that the connection between the wheel adaptor 37 and the hub 28 should not be limited to the embodiment illustrated in FIGS. 2-3. For example, the inner ring 51 of the wheel adaptor 37 and the distal mounting flange 35 of the hub 28 may be connected to the mounting flange 42 of the planetary carrier 38 at separate locations. Alternatively, the inner ring 51 may be mounted directly on the distal mounting flange 35 of the hub 28, which in turn is connected to the mounting flange 42 of the planetary carrier 38 at a separate location.

Still referring to FIG. 3, the distal rim 36 is mounted on the outer ring 52 of the wheel adaptor 37. To that end, the distal rim may include a mounting flange 62 defined about the central axis 20. The mounting flange 62 includes a proximal surface 63, a distal surface 64, and an outer edge extending between the proximal and distal surfaces (63, 64). A plurality of mounting bores 65 are provided on the mounting flange 62 about the central axis 20. The mounting bores 65 may be threaded or smooth. At least some of the mounting bores (54, 65) are in axial registration with each other so that the mounting flange 62 of the distal rim 36 can be fixedly attached to the outer ring 52, such as through a plurality of fasteners (not shown), including but not limited to studs, screws, bolts, etc. In the embodiment illustrated in FIG. 3, the mounting flange 62 is positioned proximal to the outer ring 52 with the distal surface 64 of mounting flange 62 abutting the stepped surface 60 of the outer ring 52. In other embodiments of this adaptor configuration, the mounting flange 62 may be positioned distal to the outer ring 52 with the proximal surface 63 of mounting flange 62 abutting the end surface 59 of the outer ring 52. As a result, two different tire sizes may be accommodated in the first adaptor configuration.

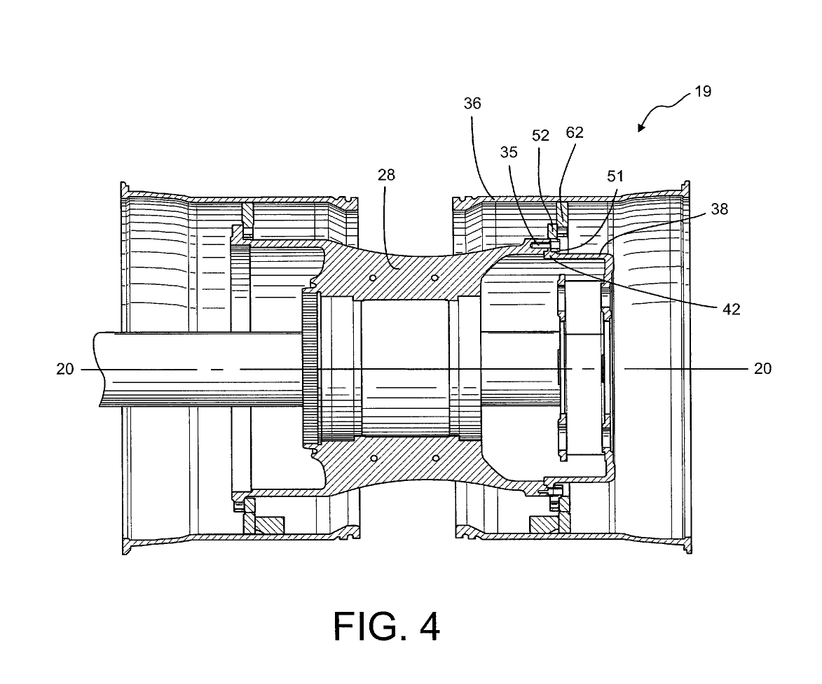

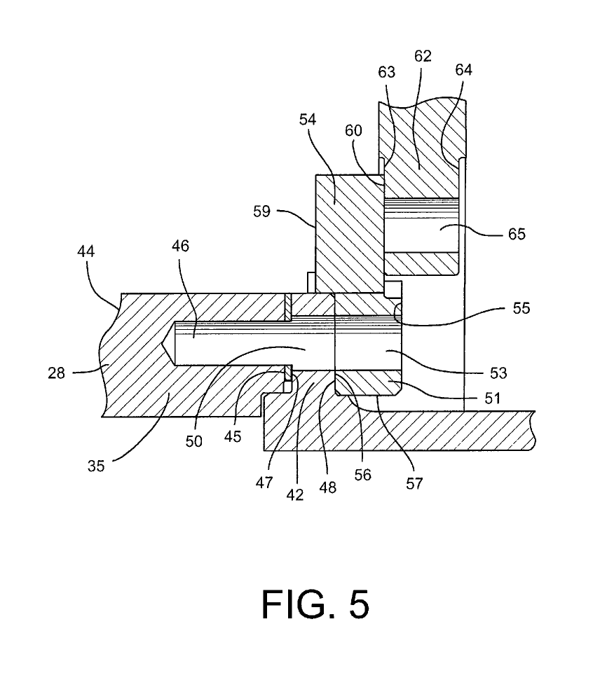

A second adaptor configuration is illustrated in FIGS. 4-5 with the outer ring 52 positioned proximal to the inner ring 51. In the non-limiting embodiment shown in FIG. 5, the stepped surface 56 of the inner ring 51 abuts against the distal surface 48 of the mounting flange 42 of the planetary carrier 38 while the proximal surface 47 of the mounting flange 42 abuts against the distal mounting flange 35 of the hub 28. At least some of the mounting bores (46, 50, 53) are in axial registration with one another so that the inner ring 51 of the wheel adaptor 37 can be fixedly connected to the distal mounting flange 35 and the mounting flange 42 of the planetary carrier 38, such as through a plurality of outer ring fasteners (not shown), including but not limited to studs, screws, bolts, etc. Again, it is to be understood that the connection between the wheel adaptor 37 and the hub 28 should not be limited to the embodiment illustrated in FIGS. 4-5. For example, the inner ring 51 of the wheel adaptor 37 and the distal mounting flange 35 of the hub 28 may be connected to the mounting flange 42 of the planetary carrier 38 at separate locations. Alternatively, the inner ring 51 may be mounted directly on the distal mounting flange 35 of the hub 28, which in turn is connected to the mounting flange 42 of the planetary carrier 38 at a separate location.

Still referring to FIG. 5, the distal rim 36 is mounted on the outer ring 52 of the wheel adaptor 37 by a plurality of fasteners (not shown) inserted through at least some of the mounting bores (54, 65) that are in axial registration with each other. In the embodiment illustrated in FIG. 5, the mounting flange 62 is positioned proximal to the outer ring 52 with the distal surface 64 of mounting flange 62 abutting the stepped surface 60 of the outer ring 52. In other embodiments of this adaptor configuration, the mounting flange 62 may be positioned distal to the outer ring 52 with the proximal surface 63 of mounting flange 62 abutting the end surface 59 of the outer ring 52.

Although the wheel adaptor 37 is used to interconnect the distal rim 36 and the hub 28 in the non-limiting embodiments illustrated in FIGS. 2-5, it is to be understood that, in other embodiment, the wheel adaptor 37 may be used to mount the proximal rim 34 on the proximal end 31 of the hub 28, while the distal rim 36 may be directly mounted on the distal end 32 of the hub 28. Moreover, in some embodiment, more than one wheel adaptor 37 may be used in the wheel assembly 19 to further increase the range of tire sizes that can be accommodated.

In order to convert between the first and second adaptor configurations, a technician or mechanic may simply remove the outer ring fasteners and inner ring fasteners so that the wheel adaptor 37 is disconnected from the hub 28 and distal rim 36. The wheel adaptor 37 is then reversed or flipped before it is remounted to the hub 28 and distal rim 36 through the inner ring fasteners and outer ring fasteners, respectively. No additional hardware is needed for such reconfiguration. Without wishing to be bound by any particular theory, it is contemplated that the “offset” spatial relationship between the inner and outer rings (51, 52) of the wheel adaptor 37 allows for a wider range of tire configurations than wheel adaptors with “aligned” inner and outer rings, an insight heretofore unknown. In addition, the disclosed wheel adaptor 37 may be lighter, easier to use, and/or mechanical more robust or durable than conventional wheel adaptors.

### INDUSTRIAL APPLICABILITY

In general, the present disclosure sets forth a wheel adaptor and wheel assembly that can accommodate a wide range of tire sizes without using additional hardware. Although the wheel adaptor and wheel assembly is described in the non-limiting embodiments as being used in an earth-moving vehicle, they may also be used in other transportation vehicles in which accommodation of different tire sizes is desirable. For example, the disclosed wheel adaptor and wheel assembly may also be used in pickup trucks, semi-trailers, or even on airplanes. Moreover, the wheel assembly may be used on non-driven wheels, in which the wheel assembly is not coupled to any final drive assembly.

While only certain embodiments have been set forth, alternative embodiments and various modifications will be apparent from the above descriptions to those skilled in the art. These and other alternatives are considered equivalents and within the spirit and scope of this disclosure.

What is claimed is:

1. A wheel adaptor comprising:
an inner ring; and
an outer ring fixedly connected to the inner ring, the inner and outer rings being concentric around an axis, the inner and outer rings being offset from each other.

2. The wheel adaptor of claim 1, wherein the inner ring comprises a plurality of axially extending hub-mounting bores.

3. The wheel adaptor of claim 2, wherein the hub-mounting bores are evenly distributed around the axis.

4. The wheel adaptor of claim 1, wherein the outer ring comprises a plurality of axially extending wheel-mounting bores.

5. The wheel adaptor of claim 4, wherein the wheel-mounting bores are evenly distributed around the axis.

6. The wheel adaptor of claim 1, wherein the inner and outer rings have essentially same axial thickness.

7. The wheel adaptor of claim 1, wherein the inner and outer rings are integrated into one-piece.

8. A wheel assembly comprising:
a hub;
a first wheel; and
a wheel adaptor, the wheel adaptor including an inner ring connected to the hub and an outer ring connected to the first wheel, the inner and outer rings being concentric around an axis, the inner and outer rings being offset from each other.

9. The wheel assembly of claim 8, wherein the inner ring is connected to a mounting flange of the hub.

10. The wheel assembly of claim 8, wherein the outer ring is connected to a mounting flange of the first wheel.

11. The wheel assembly of claim 10, wherein the outer ring is positioned distally to the inner ring.

12. The wheel assembly of claim 10, wherein the outer ring is positioned proximally to the inner ring.

13. The wheel assembly of claim 8, wherein the inner and outer rings have essentially same axial thickness.

14. The wheel assembly of claim 8, wherein the inner and outer rings are integrated into one-piece.

15. The wheel assembly of claim 8, further comprising a second wheel mounted on the hub.

16. The wheel assembly of claim 15, wherein the second wheel is proximal to the first wheel.

17. A method for reconfiguring a wheel assembly including a hub, a wheel, and an adaptor interconnecting the hub and wheel, the method comprising:
disconnecting the wheel and adaptor;
disconnecting the adaptor and hub;
reversing the adaptor;
reconnecting the adaptor and hub; and
reconnecting the wheel and adaptor.

18. The method of claim 17, wherein the adaptor comprises an inner ring connected to the hub and an outer ring connected to the first wheel, the inner and outer rings being concentric around an axis, the inner and outer rings being offset from each other.

19. The wheel assembly of claim 18, wherein the inner and outer rings have essentially same axial thickness.

20. The wheel assembly of claim 18, wherein the inner and outer rings are integrated into one-piece.
